(19) United States
(12) Patent Application Publication
(10) Pub. No.: US 2014/0260773 A1
(43) Pub. Date: Sep. 18, 2014

(54) INJECTION MOLD FOR A BICYCLE HANDLEBAR GRIP, METHOD FOR PRODUCING A BICYCLE HANDLEBAR GRIP, AND BICYCLE HANDLEBAR GRIP

(71) Applicant: RTI Sports Vertrieb von Sportartikeln GmbH, Koblenz (DE)

(72) Inventor: Franc Arnold, Koblenz (DE)

(73) Assignee: RTI Sports Vertrieb von Sportartikeln GmbH, Koblenz (DE)

(21) Appl. No.: 14/212,282

(22) Filed: Mar. 14, 2014

(30) Foreign Application Priority Data
Mar. 15, 2013 (DE) 102013204564.6

(51) Int. Cl. B62K 21/26; B29C 45/16; B29C 45/14

(52) U.S. Cl. CPC B62K 21/26; B29C 45/14065; B29C 45/1671
USPC 74/551.9; 425/129.1; 264/279

(57) ABSTRACT

A bicycle handlebar grip comprises at least one surface element made e.g., of leather. The surface elements are each surrounded by a groove. For producing the bicycle handlebar grip with the respective groove, an injection mold comprises two mold portions provided with a web-shaped holding element. Each web-shaped holding element surrounds an insertion area for the surface elements.

### BACKGROUND

1. Field of the Disclosure

The present disclosure relates to an injection mold for a bicycle handlebar grip, a method for producing a bicycle handlebar grip, and a bicycle handlebar grip.

2. Description of the Prior Art

In the field of bicycle handlebar grips, it is known that these grips comprise a sleeve made of relatively hard plastic that can be connected to the bicycle handlebar, particularly by clamping, and that is surrounded by softer plastic. In this manner, it is possible, on the one hand, to realize a tight connection between the bicycle handlebar grip and the bicycle handlebar via said sleeve of hard plastic and, on the other hand, to provide a plastic material having a softer dampening effect. This is of advantage particularly in bicycle handlebar grips which comprise a support element for the ball of the thumb. The arrangement makes it possible to realize a soft support for the ball of the thumb while, at the same time, the moments acting on the bicycle handlebar grip via a wing-shaped support for the ball of the thumb that is spaced from the bicycle handlebar, will be transmitted to the bicycle handlebar grip via the sleeve made of harder plastic. This is required for avoiding a twisting of the bicycle handlebar grip on the bicycle handlebar. The above bicycle handlebar grip design comprising a harder sleeve for clamping attachment to the bicycle handlebar is also advantageous in cases where a grip horn has been connected to the bicycle handlebar grip, since it will prevent a twisting movement of the grip horn—possibly together with the bicycle handlebar grip—on the bicycle handlebar. Of particular advantage in such a design comprising a hard and a soft plastic is a combination of a bicycle handlebar grip with grip horn and a support element for the ball of the thumb. Such bicycle handlebar grips are described e.g. in EP 1 712 460, EP 1 537 014 and EP 1 919 762.

The softer plastic surrounding the sleeve has to fulfill the requirement of allowing, on the one hand, for a good connection to the sleeve and, on the other hand, for the necessary damping properties. Further, the softer plastic must have the required haptics as well as anti-slip properties and is the like.

It is an object of the disclosure to provide a bicycle handlebar grip wherein the properties of the outer layer of the grip material are selectable. It is a further object of the disclosure to provide a corresponding injection mold and a method for producing such a bicycle handlebar grip.

### SUMMARY

An essential element of the disclosure resides in that the bicycle handlebar grip comprises a surface element produced from an areal material such as, particularly, leather, imitation leather, felt, tissue and the like. A corresponding surface element is arranged in the bicycle handlebar grip in the manner of an insert element and is fixed on the bicycle handlebar grip. By the provision of a surface element, particularly made of leather, the design as well as the haptics and the damping properties of the bicycle handlebar grip can be varied.

The injection mold of the disclosure for producing such a bicycle handlebar grip comprises an upper and a lower mold portion. Said two mold portions will be closed for forming the bicycle handlebar grip, followed by the injection of the plastic material which usually is an elastomer such as e.g. TPU. To make it possible to arrange a surface element in one of the two mold portions, i.e. in a future upper side or lower side of the bicycle handlebar grip, at least one of the mold portions comprises an insertion area for insertion therein of the surface element such as e.g. a piece of leather that has been cut to size. The insertion area is preferably formed as an insertion depression. Preferably, in this arrangement, the surface element is across a major portion of it supported by the insertion area. Particularly, a major portion of the surface element is arranged in contact with the insertion area. With particular preference, the surface element is supported over its full surface by the insertion area through full-surfaced mutual contact of the surface element and the insertion area. In this manner, there is achieved a smooth surface of the surface element on the future upper side of the element. Particularly, the inserting of the surface element into the insertion area will be performed in the open state of the injection mold. For fixing the surface element in the insertion area, the latter is provided with at least one holding element, arranged on the edge of the insertion area, for fixing the surface element in the mold portion. With the aid of the holding element, which is realized e.g. in the form of pins or projections, the surface element will be fixed in the insertion area, particularly by camping action.

Preferably, a plurality of insertion areas are provided, there being particularly provided one insertion area per mold portion. In a preferred embodiment of the design comprising one insertion area per mold portion, the insertion areas are arranged in such a manner that, in the completed bicycle handlebar grip, the two surface elements are located opposite to each other, particularly on an upper side and a lower side of the bicycle handlebar grip. Further, it is preferred that the surface elements have sizes which in combination cover a major portion of the surface of the bicycle handlebar grip. Preferably, more than 90% and with particular preference more than 95% of the surface of the bicycle handlebar grip are covered by the surface element.

According to a particularly preferred embodiment of the disclosure, the holding element for holding the surface element in one of the two mold portions, is web-shaped. Preferably, the web-shaped holding element forms the edge of the insertion area. According to a particularly preferred embodiment, the web-shaped holding element is closed in itself so that the web-shaped holding element fully surrounds the insertion area and respectively the surface element inserted in the insertion area. First, there is guaranteed a safe fixation of the surface element in the mold portion. A web-shaped holding element fully surrounding the insertion area and thus the surface element further has the advantage of preventing that the plastic material injected into the injection mold could happen to reach the upper side of the surface element. It is thus prevented that, during the injection molding, plastic material could advance between the injection mold and the surface element and consequently, after completion of the bicycle handlebar grip, could appear on the upper side of the surface element. However, particularly also a web-shaped holding element which surrounds the insertion area partially, will be suitable for fixing the inserted surface element in a secure manner. The edge of the insertion area, which particularly is formed by the web-shaped holding element closed in itself, is preferably arranged at a substantially constant distance to a partial wall of the mold provided for forming the grip edge. Thus, in the completed bicycle handlebar grip, a distance between the grip edge and the surface element is substantially constant.

According to a preferred embodiment, at least one of the two mold portions is provided with a groove-shaped recess surrounding—particularly completely—the particularly web-shaped holding element and respectively the edge of the insertion area. During the injection molding process, plastic material will enter this recess so that, in the completed bicycle handlebar grip, the surface element is fully surrounded by a bead or edge of plastic material wherein, between said bead or edge and the surface element, there is arranged a groove or notch which is formed by the web-shaped holding element.

Further, it is preferred that said at least one insertion area which is formed in the upper and/or lower mold portion has a distance of less than 8 mm to the grip edge. Of particular preference is a constant distance. Preferably, the distance is in the range 5 to 3 mm. In this manner, there is substantially realized an insertion area over the whole inner surface of one of the two mold portions, and, if two mutually opposite insertion areas are provided, over the whole inner surface of both mold portions.

In case that the bicycle handlebar grip produced by the injection molding process comprises an inner sleeve with or without a skeleton-like projection, as described e.g. in EP 1 712 460, it is further preferred that the two mold portions comprises sleeve take-up portions for insertion of the sleeve thereinto.

The disclosure further relates to a method for producing a bicycle handlebar grip, wherein the method of the disclosure, according to a particularly preferred embodiment, is carried out by use of the above described injection mold. First, the at least one surface element will be inserted into the at least one insertion area in a mold portion of the injection mold, with the injection mold preferably comprising two mold portions. After insertion of the at least one surface element into one or both mold portions, the injection mold will be closed and, subsequently, the injection molding material, which particularly is an elastomer such as e.g. TPU, will be injected. Prior to closing, it is of course possible to insert a plurality of differently designed surface elements into various insertion areas. These is surface elements can differ from each other in their shape and/or their material. It is possible, for instance, that an upper side of a bicycle handlebar grip is provided with an insertion element made of a different material and/or having different material properties from those of the insertion element on the lower side of the bicycle handlebar grip.

In case that the bicycle handlebar grip comprises a stiffening element such as e.g. a sleeve having a skeleton-like, wing-shaped projection, as described particularly in EP 1 712 460, also said stiffening element can be inserted into the injection mold prior before the latter will be closed. Then, the injection molding material will be injected so that this material will be introduced particularly between the sleeve-like stiffening element and the surface element and will safeguard a tight connection. Further, a part of the injected injection molding material will reach a region which will be visible in the completed state of the bicycle handlebar grip. This region will particularly be a web or a material region which in the completed state of the bicycle handlebar grip will surround the surface element(s), optionally at a distance.

The disclosure further relates to a bicycle handlebar grip which is produced preferably with the aid of the above described method and, particularly, additionally by use of the above described injection mold.

Said bicycle handlebar grip comprises at least one surface element forming at least a part of the grip surface. It is preferred—as already described above in the context of the injection mold and the method—to provide particularly two, preferably mutually opposite surface elements which form substantially the whole surface of the bicycle handlebar grip. According to the disclosure, said at least one surface element is surrounded by a groove. This groove is particularly formed by the web-shaped holding element arranged in the injection mold. In case of a plurality of surface elements, it is preferred that each individual surface element is surrounded by a separate groove. Preferably, in such an arrangement, the groove surrounds the surface element only partially, particularly if the web-shaped holding element formed in the injection mold surrounds the insertion area only partially. With particular preference, however, the groove surrounds the surface element fully.

Further, it is preferred to provide a separating web, made of the injection molding material, between adjacent surface elements. It is particularly preferred that, in a bicycle handlebar grip which comprises two surface elements arranged particularly opposite to each other, two such separating webs are provided in the assembled state of the bicycle handlebar grip, which are particularly arranged in the same horizontal plane.

According to a particularly preferred embodiment, the at least one surface element, particularly all of the surface elements, is/are respectively surrounded by a web of plastic injection molding material, wherein, between said web and the surface element, a groove is provided which likewise fully surrounds the surface element. In spite of the groove, which is formed particularly by the web-shaped holding element of the injection mold, the web of plastic material will offer protection of the lateral faces of the surface element. Particularly, neither the upper side of said at least one surface element nor the upper side of the webs is protruding, so that these partions form a particularly closed surface and respectively lie in a curved surface.

### BRIEF DESCRIPTION OF THE DRAWINGS

A full and enabling disclosure of the present disclosure, enabling one of ordinary skill in the art to carry out the disclosure, is set forth in greater detail in the following description, including reference to the accompanying drawing in which

FIG. 1 is a schematic plan view of a bicycle handlebar grip produced according to the disclosure,

FIG. 2 is a schematic lateral view of the bicycle handlebar grip of FIG. 1 as seen in the direction of arrow II,

FIG. 3 is a schematic plan view of a sleeve arranged within the bicycle handlebar grip,

FIG. 4 is a schematic plan view of the two mold portions of an injection mold for producing the bicycle handlebar grip of FIG. 1, and

FIG. 5 is a schematic cross-sectional view of the closed injection mold.

### DETAILED DESCRIPTION OF PREFERRED EMBODIMENTS

A bicycle handlebar grip comprises a sleeve 10 (FIG. 3) arranged within the bicycle handlebar grip. Sleeve 10 comprises a clamping area 12 for connecting the sleeve, and thus the bicycle handlebar grip connected to the sleeve, to a bicycle handlebar by clamping attachment. For this purpose, the sleeve comprises a sleeve slot 14 within the clamping area 12. Clamping is performed by use of a collar-like clamping means 16 (FIG. 1) with the aid of a screw 18, schematically outlined in FIG. 1. The bicycle handlebar grip comprises two mutually opposite surface elements 20, 22 which particularly are realized as leather elements. Surface element 20, which in the assembled state is the upper surface element, comprises a structured surface area 24 generated e.g. by a laser process, by which the roughness is improved, thus preventing the cyclist's hand to slip off the bicycle handlebar grip. The surface element particularly made of leather is surrounded by a groove 26. The surface elements 20, 22, of which two are provided in the illustrated embodiment, are surrounded separately and fully by groove 26. By way of alternate, a groove can be provided which surrounds at least one surface element only partially.

In the representation according to FIG. 1, a respective web-shaped portion 28 is provided laterally to the left and to the right of groove 26. Said portion 28 consists of the plastic material injected into the injection mold. Web 28 merges into a separating web 30 (FIG. 2), said separating web 30 extending between the two surface elements 20, 22 in the longitudinal direction of the grip. In the assembled state of the grip, the separating web 30 extends in a horizontal plane, wherein a further separating web is arranged opposite to separating web 30.

Except for groove 26, the surfaces 32, 34 of the two surface elements 20, 22 merge in a stepless manner into the surface 36 of the webs 28 and respectively of the separating webs 30.

For producing the bicycle handlebar grip, two mold portions 38, 40 (FIG. 4) are provided, being of a substantially mirror-symmetrical design. Said mold portions 38, 40 each comprise a recess so that each mold portion 38, 40 forms a recess for producing a respective half of the future bicycle handlebar grip. Each mold portion 38, 40 comprises an insertion area 42. In its edge region, each insertion area 42 is fully surrounded by a web-shaped holding element 44. The web-shaped holding element is in outward direction followed by a groove-shaped recess 46 which likewise fully surrounds the web-shaped holding element 44 and has a substantially constant width. The surface 48 following said recess 46 is planar, wherein the two surfaces 48 are in abutment on each other in the closed state of the injection mold (FIG. 5).

For producing the bicycle handlebar grip of the disclosure, the two surface elements, which are particularly made of leather and are exactly cut to size, will be inserted into the two insertion areas 42 in the opened injection mold, wherein, in the illustrated embodiment, the surface element will come into full-faced abutment on the insertion area. The inserted surface elements will be held by the webs 44. This necessitates a certain stiffness of the surface elements and requires that the surface elements are precisely cut to size.

In the next step, the sleeve 10 (FIG. 3) will be inserted into corresponding sleeve take-up portions 50 which are each formed as semicylinder.

Subsequently, the injection mold will be closed by moving the two mold portions 38, 40 onto each other, and plastic material will be injected into the injection mold.

FIG. 5 is a sectional view of the closed injection mold as seen substantially at the height of line V in FIG. 4.

The webs 44 surrounding the insertion areas 42 extend inward, with the two surface elements 20, 22 being inserted into the respective insertion areas 42. Further, in said sectional view, sleeve 10 is illustrated within the interior. Between the sleeve 10 and the two surface elements 20, 22, plastic material will be injected into the closed injection mold. The plastic material provides an intermediate layer 52 between the sleeve 10 and the surface elements 20, 22 and also forms the webs 36, 26 and the two mutually opposite separating webs 30.

Although the disclosure has been described and illustrated with reference to specific illustrative embodiments thereof, it is not intended that the disclosure be limited to those illustrative embodiments. Those skilled in the art will recognize that variations and modifications can be made without departing from the true scope of the disclosure as defined by the claims that follow. It is therefore intended to include within the disclosure all such variations and modifications as fall within the scope of the appended claims and equivalents thereof.

What is claimed is:

1. An injection mold for a bicycle handlebar grip, said injection mold comprising
an upper and a lower mold portion,
an insertion area provided in at least one of the two mold portions for insertion of at least one surface element of the bicycle handlebar grip in the injection mold, and
at least one holding element provided at the edge of the insertion area for fixing the at least one surface element in the mold portion.

2. The injection mold of claim 1, wherein a plurality of insertion areas are provided, particularly one insertion area per mold portion.

3. The injection mold of claim 1, wherein the holding element is web-shaped and preferably fully surrounds the insertion area.

4. The injection mold of claim 2, wherein the at least one insertion area extends substantially across a whole inner surface of the mold portion.

5. The injection mold of claim 1, wherein the edge of the at least one insertion area extends substantially parallel to a partial wall of the mold forming the grip edge.

6. The injection mold of claim 1, wherein at least one of the two mold portions is provided with a groove-shaped recess surrounding the web-shaped holding element particularly fully.

7. A method for producing a bicycle handlebar grip, particularly by use of an injection mold of claim 1, said method comprising the steps of:
inserting a surface element into an insertion area of a mold portion of the injection mold,
closing the injection mold, and
injection of injection molding material.

8. The method of claim 7, comprising the additional step of:
inserting at least one further surface element particularly into a second mold portion.

9. The method of claim 7, comprising the additional step of:
inserting a stiffening element made particularly of plastic.

10. A bicycle handlebar grip, produced particularly according to the method of claim 7 and particularly by use of an injection mold for a bicycle handlebar grip, said injection mold comprising: an upper and a lower mold portion, an insertion area provided in at least one of the two mold portions for insertion of at least one surface element of the bicycle handlebar grip in the injection mold, and at least one holding element provided at the edge of the insertion area for fixing the at least one surface element in the mold portion, said bicycle handlebar grip comprising:
at least one surface element forming at least a part of the grip surface, and
a groove surrounding the surface element.

11. The bicycle handlebar grip of claim 10, wherein, in case that a plurality of surface elements are provided, each of them is surrounded by an individual groove.

12. The bicycle handlebar grip of claim 10, wherein a separating web made of plastic injection material is provided between adjacent surface elements.

13. The bicycle handlebar grip of claim 10, wherein at said least one surface element and particularly all surface elements is/are surrounded by a web made of plastic injection material.
